(19) United States
(12) Patent Application Publication
(10) Pub. No.: US 2025/0042180 A1
(43) Pub. Date: Feb. 6, 2025

(54) LABEL PRINTER

(71) Applicant: BROTHER KOGYO KABUSHIKI KAISHA, Nagoya (JP)

(72) Inventors: Keigo KAKO, Nagoya (JP); Koichi KONDO, Inuyama (JP)

(21) Appl. No.: 18/781,535

(22) Filed: Jul. 23, 2024

(30) Foreign Application Priority Data
Jul. 31, 2023 (JP) 2023-124190

(51) Int. Cl. B41J 3/407; B41J 11/70; B41J 15/04; B41J 29/387

(52) U.S. Cl. CPC B41J 3/4075; B41J 11/703; B41J 15/042; B41J 15/044; B41J 29/387

(57) ABSTRACT

A label printer includes a print head, a roller, a display, and a processor. The roller is configured to convey a tape. The processor is configured to execute continuous printing processing of driving the print head and the roller based on print data to perform continuous printing on the tape, re-start number reception processing of, when re-starting the continuous printing subsequent to interruption of the continuous printing processing, displaying, on the display, a value corresponding to a number of printed copies already printed at the time of interruption, as an initial value of a re-start number, and receiving input of the re-start number, and print re-start processing of driving the print head and the roller based on the print data to re-start the continuous printing from the re-start number.

### REFERENCE TO RELATED APPLICATIONS

This application claims priority from Japanese Patent Application No. 2023-124190 filed on Jul. 31, 2023. The entire content of the priority application is incorporated herein by reference.

### BACKGROUND ART

The present disclosure relates to a label printer.

A print device according to related art has a built-in dry battery or rechargeable battery as a power source, and includes a control unit, a storage unit, an input unit, a display unit, and a printing unit. The print device determines print conditions and sets an operation reference voltage based on the determined print conditions. When the printing is performed, the print device compares a detected battery voltage and the set operation reference voltage, and when the battery voltage is lower than the operation reference voltage, notifies that the battery voltage is insufficient, using the display unit.

### SUMMARY

When insufficient voltage occurs during continuous printing in the print device according to the related art described above, there is a case in which the continuous printing is interrupted, the power source of the print device turned off, and the battery is replaced. When the continuous printing is re-started after replacing the battery and turning the power source on, it is necessary for a user to specify where to re-start the printing from. In order to re-start the continuous printing, an operation to verify up to where the printing has been performed is complex.

Embodiments of the broad principles derived herein provide a label printer capable of re-starting continuous printing using a simple operation, even when the continuous printing is interrupted.

Embodiments provide a label printer that includes a print head, a roller, a display, and a processor. The roller is configured to convey a tape. The processor is configured to execute continuous printing processing of driving the print head and the roller based on print data to perform continuous printing on the tape, re-start number reception processing of, when re-starting the continuous printing subsequent to interruption of the continuous printing processing, displaying, on the display, a value corresponding to a number of printed copies already printed at the time of interruption, as an initial value of a re-start number, and receiving input of the re-start number, and print re-start processing of driving the print head and the roller based on the print data to re-start the continuous printing from the re-start number. The label printer displays, on the display, the value corresponding to the number of printed copies, as the initial value of the re-start number, and thus, a user can specify the re-start number while referring to the initial value. As a result, the label printer contributes to re-starting the continuous printing using a simple operation compared to related art, even when the continuous printing is interrupted.

### BRIEF DESCRIPTION OF DRAWINGS

FIG. 1 is a front view of a label printer.

FIG. 2 is a perspective view of the label printer when a rear surface cover is open.

FIG. 3A is a partial cross-sectional view, as seen from the rear side, of a roller holder in a state in which the rear surface cover has been closed and is at a closed position, and FIG. 3B is a partial cross-sectional view, as seen from the rear side, of the roller holder in a state in which the rear surface cover has been opened and is in an open state.

FIG. 4 is a block diagram showing an electrical configuration of the label printer.

FIG. 5 is an explanatory diagram showing transitions of screens displayed on a display, in specific examples.

FIG. 6 is a flowchart of main processing.

FIG. 7 is a flowchart of normal mode processing performed in the main processing.

FIG. 8 is a flowchart of label print processing performed in each of the normal mode processing and continuous mode processing.

FIG. 9 is a flowchart of the continuous mode processing performed in the main processing.

FIG. 10 is a flowchart of the normal mode processing performed in the main processing according to a modified example.

FIG. 11 is a flowchart of the continuous processing performed in the main processing according to a modified example.

### DESCRIPTION

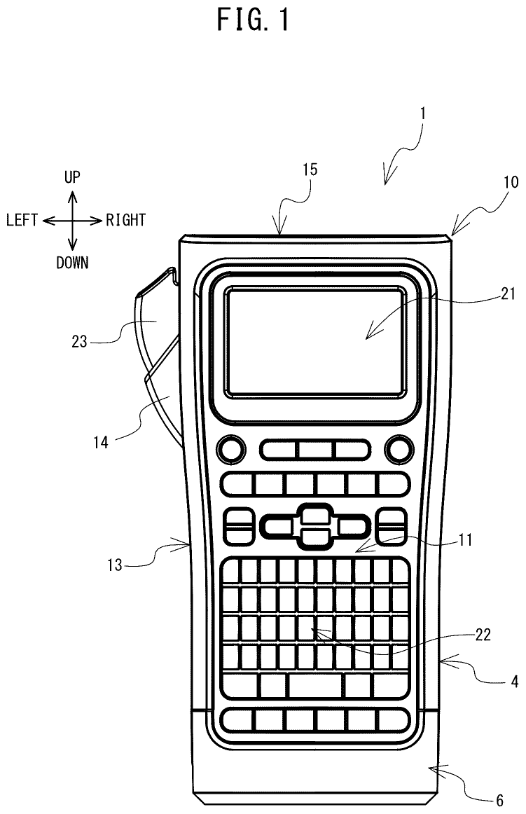

An embodiment of the present disclosure will be described below with reference to the accompanying drawings. The up-down direction, and the left-right direction in FIG. 1 are, respectively, the up-down direction and the left-right direction of a label printer (hereinafter referred to as a “printer”) 1. Note that the up-down direction and the left-right direction of the printer 1 are defined for sake of convenience, and the printer 1 is not necessarily limited to being in the posture shown in FIG. 1.

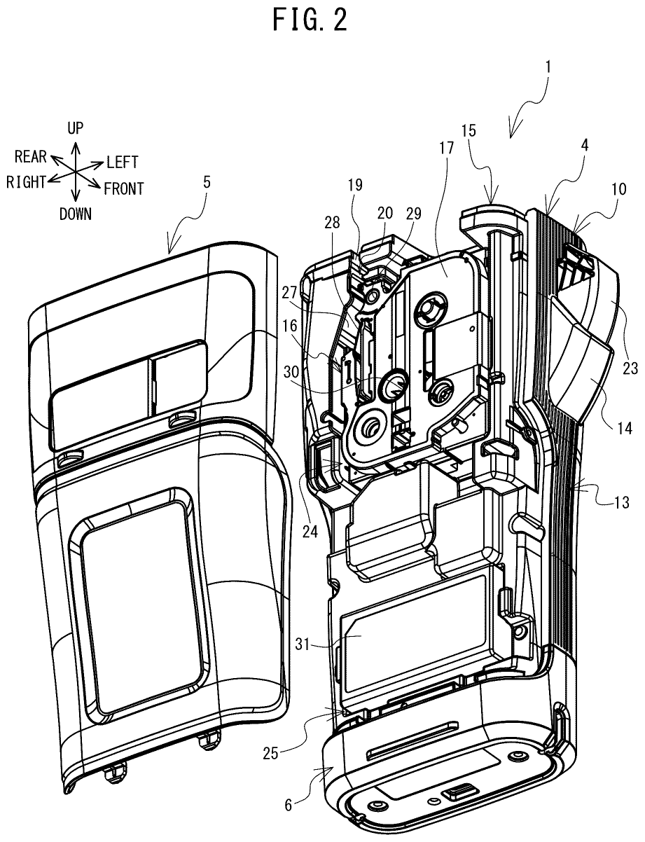

As shown in FIG. 1 to FIG. 3B, the printer 1 is a portable label printer that is configured to print an image on a tape M pulled out from a cassette 17, and create a label. The printer 1 can use, for example, the cassette 17 housing various types of tape, such as a receptor type, a thermal type, a laminate type, a tube type, or the like. The tape M is, for example, one of a single-sided adhesive tape, a heat sensitive paper tape, a double-sided adhesive tape, a film tape, or a tube tape. An indicator 16 that indicates the type of the tape M is provided on the right surface of the cassette 17. The indicator 16 includes at least one hole portion provided in a predetermined pattern according to the type of the tape M. The printer 1 is configured to print an image, such as characters, graphics and the like, on the tape M.

The printer 1 is provided with a housing 10, a display 21, an input portion 22, and an operation lever 23. The housing 10 is a cuboid shape that is long in the up-down direction, and is provided with a main body portion 4, a rear surface cover 5, a lower cover 6, and a protruding portion 14. The main body portion 4 is a cuboid shape with an open rear surface. The rear surface cover 5 is removably attached to the main body portion 4. A discharge opening 19, which penetrates in the up-down direction, is formed in a top surface 15 of the housing 10. The lower cover 6 is a cuboid shape that is open upward. The lower cover 6 is removably attached to the main body portion 4, and protects a lower portion of the main body portion 4. The protruding portion 14 is a portion provided at an upper end portion of a left surface 13 of the housing 10, and protrudes to the left. An upper portion of the protruding portion 14 is open.

The display 21 is a liquid crystal display, for example, and is configured to display various information. The display 21 is provided at a position further to the upper side than a substantial center, in the up-down direction, of a front surface 11 of the housing 10. The input portion 22 receives various information input by a user operation. The input portion 22 is provided to the lower side of the display 21 in the front surface 11 of the housing 10. The input portion 22 includes various switches, such as a print button, a Shift key, and an Esc key. The operation lever 23 is rotatably supported inside the housing 10, and a portion on the lower side of the operation lever 23 is covered by the protruding portion 14. In accordance with an operation by the user, a portion of the operation lever 23 exposed to the outside of the housing 10 moves in and out of the housing 10, via an opening in the protruding portion 14.

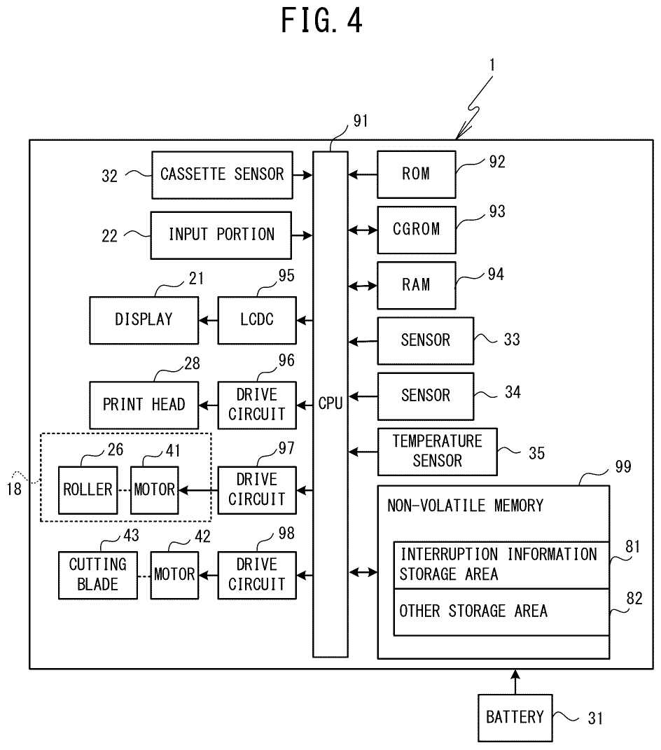

In the interior of the housing 10, more specifically, in front of the rear surface cover 5 in the interior of the main body portion 4, the printer 1 is provided with a cassette compartment 24, a battery compartment 25, a print head 28, a temperature sensor 35, a drive mechanism 18 (refer to FIG. 4), a roller holder 27, a cutting mechanism 20, and the like. The cassette 17 is detachably installed in the cassette compartment 24. The cassette compartment 24 is a recessed portion, recessed to the front, that is provided higher than a center, in the up-down direction, of the main body portion 4 of the housing 10. The battery compartment 25 houses a battery 31. The battery compartment 25 is a recessed portion, recessed to the front, that is provided lower than the center, in the up-down direction, of the main body portion 4 of the housing 10. When the rear surface cover 5 is removed from the main body portion 4, the cassette compartment 24 and the battery compartment 25 are exposed to the outside of the printer 1. The user can replace each of the cassette 17 and the battery 31 in the state in which the rear surface cover 5 is removed from the main body portion 4.

The print head 28 is a thermal head configured to perform the printing on the tape M. The printer 1 repeatedly conveys the tape M from the cassette compartment 24 by the driving of a roller drive shaft 29. By heating an ink ribbon, using the print head 28, and transferring ink from the ink ribbon onto the tape M, the printer 1 performs the printing on the tape M. The temperature sensor 35 is provided in a surrounding space including the print head 28. The temperature sensor 35 according to the present embodiment is provided to the front of the print head 28 and is configured to detect the temperature of the print head 28. The drive mechanism 18 is provided with a motor 41, a roller 26, the roller drive shaft 29, and a ribbon take-up shaft 30. The roller drive shaft 29 rotates the roller 26, using motive power of the motor 41, and pulls out and conveys the tape M inside the cassette 17. The ribbon take-up shaft 30 rotates due to the motive power of the motor 41, pulls out the ink ribbon inside the cassette 17, and further takes up the ink ribbon that has passed the print head 28.

The roller holder 27 extends in the up-down direction to the right of the cassette compartment 24. The roller holder 27 is axially supported, at a lower end portion of the roller holder 27, so as to be rotatable around a rotation shaft 45 extending in the front-rear direction. The roller holder 27 axially supports a platen roller 47 and a tape sub roller 46 to be rotatable in the counterclockwise direction in a rear surface view. The platen roller 47 is provided to the right of the print head 28. The tape sub roller 46 is provided to the right of the roller drive shaft 29 and above and in the vicinity of the platen roller 47. In the roller holder 27, a cassette sensor 32 is disposed between the platen roller 47 and the rotation shaft 45 in the up-down direction. The cassette sensor 32 is provided with a plurality of detection switches 36 that detect the presence or absence of each of hole portions of the indicator 16 provided on the right surface of the cassette 17. Each of the plurality of detection switches 36 extends in the left-right direction. A spring (not shown in the drawings) urges the roller holder 27 to rotate to the right around the rotation shaft 45. In a state in which the cassette 17 is installed in the printer 1, when the rear surface cover 5 is closed, the roller holder 27 is pushed to the left, and rotates to the left in resistance to the urging force of the spring (not shown in the drawings).

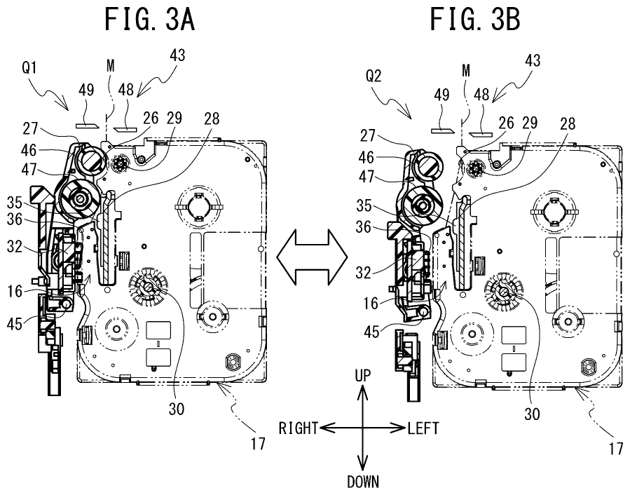

As shown by a state Q1 in FIG. 3A, in the state in which the cassette 17 is installed in the printer 1, when the rear surface cover 5 is closed, the cassette sensor 32 is disposed in the vicinity of the cassette 17 as a result of the roller holder 27 rotating to the left. When the cassette sensor 32 is disposed in the vicinity of the cassette 17, the plurality of detection switches 36 of the cassette sensor 32 are selectively pressed by the indicator 16 of the cassette 17. The cassette sensor 32 outputs a detection signal based on a combination of on/off states of the plurality of detection switches 36 at that time. As shown by a state Q2 in FIG. 3B, when the rear surface cover 5 is opened, or when the cassette 17 is not installed, the cassette sensor 32 is separated from the cassette 17 as a result of the roller holder 27 rotating to the right. When the cassette sensor 32 is separated from the cassette 17, none of the plurality of detection switches 36 of the cassette sensor 32 are pressed by the indicator 16, and thus, the cassette 17 cannot be detected.

The cutting mechanism 20 is provided below the discharge opening 19. The cutting mechanism 20 is provided with a cutting blade 43 (refer to FIG. 4) formed by a movable blade 49 and a fixed blade 48. As a result of the operation lever 23 being operated and pressed diagonally downward and to the right, and being pressed into the inside of the housing 10, the movable blade 49 of the cutting blade 43 is operated to cut the tape M. The tape M cut by the cutting blade 43 is discharged to the outside of the housing 10 from the discharge opening 19.

The electrical configuration of the printer 1 will be described with reference to FIG. 4. As shown in FIG. 4, the printer 1 is provided with a CPU 91, a ROM 92, a CGROM 93, a RAM 94, and a non-volatile memory 99. The ROM 92, the CGROM 93, the RAM 94, and the non-volatile memory 99 are each electrically connected to the CPU 91.

Various programs and the like necessary for controlling the printer 1 are stored in the ROM 92. The CPU 91 performs various arithmetic calculations based on these programs. Print dot pattern data for printing various print objects are categorized according to font and size and associated with code data, and the associated data is stored in the CGROM 93. Thus, as long as characters, font, and size are established, the printer 1 can identify the size of the print object. A plurality of storage areas, such as a text memory, a print buffer, and the like, are provided in the RAM 94. Data of the print object, input from the input portion 22, are stored in the text memory. The print dot pattern of the print object is stored in the print buffer.

The non-volatile memory 99 is provided with an interruption information storage area 81, and another storage area 82. The interruption information is information stored when continuous printing processing is interrupted, and the interruption information according to the present embodiment includes at least one selected from a group of a number of printed copies and an initial value, together with print data, and print settings. The other storage area 82, for example, stores relationships between the signal output by the cassette sensor 32, the type of the cassette 17, and a width and length of the tape M housed in the cassette 17.

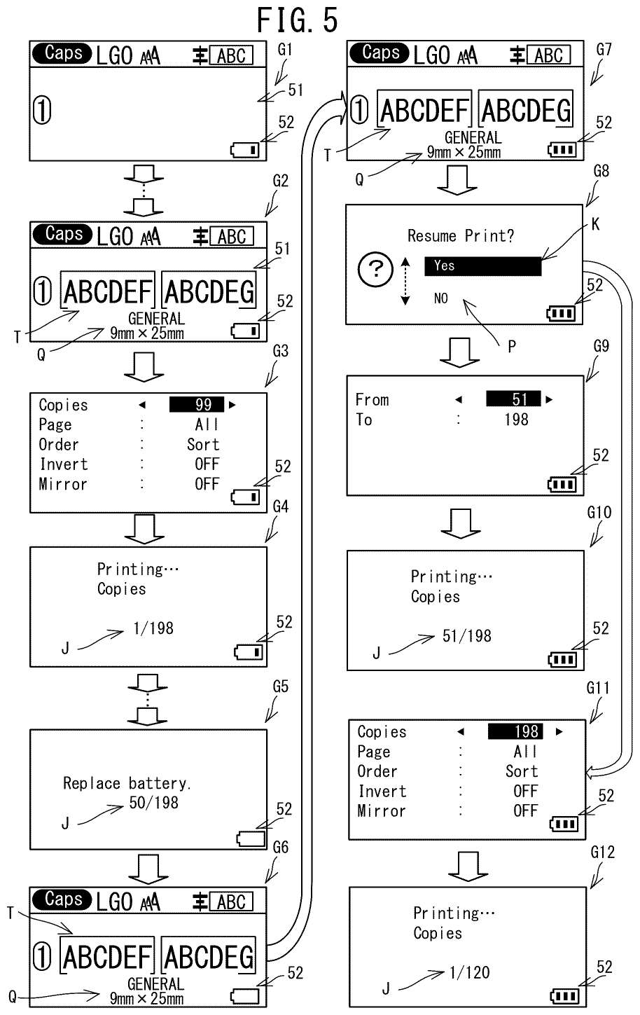

The printer 1 is further provided with the cassette sensor 32, sensors 33 to 34, and the temperature sensor 35, the input portion 22, a liquid crystal drive circuit (LCDC) 95, and drive circuits 96 to 98. The sensors 32 to 35, the input portion 22, the LCDC 95, and the drive circuits 96 to 98 are each electrically connected to the CPU 91. The cassette sensor 32 inputs, to the CPU 91, the detection signal according to the type of the cassette 17. The sensor 33 is a sensor that is configured to output a detection signal according to a voltage applied to the print head 28. Based on the detection signal of the sensor 33, the CPU 91 determines whether the sufficient voltage is being applied to the print head 28, that is, determines whether a remaining charge of the battery 31 is sufficient. The sensor 33, for example, may be a remaining battery charge meter IC using one of a voltage measuring method or coulomb counter method, battery cell/modeling method, and an impedance/tracking method. The sensor 34 is configured to input, to the CPU 91, a detection signal indicating whether the movable blade 49, of the cutting blade 43, is at an origin position (a position at which the movable blade 49 is fully open with respect to the fixed blade 48. The sensor 34 is, for example, a sensor switch disposed at a position in contact with the movable blade 49 when the movable blade 49 of the cutting blade 43 is at the origin position. The temperature sensor 35 is configured to input, to the CPU 91, a detection signal according to the temperature of the print head 28. The drive circuit 96 is an electronic circuit for driving the print head 28. The drive circuit 97 is an electronic circuit for driving the motor 41 that is configured to rotate the ribbon take-up shaft 30 and the roller drive shaft 29. The drive circuit 98 is an electronic circuit for driving a motor 42 that is configured to operate the movable blade 49 of the cutting blade 43, which cuts the tape M discharged to the outside of the printer 1. The motors 41 and 42 are stepping motors. The type of the motors 41 and 42 can be changed as appropriate, and a DC servo motor may be employed, for example. The LCDC 95 is an electronic circuit for displaying images, such as various icons or a preview of a label to be printed, for example, on the display 21, as shown in FIG. 5.

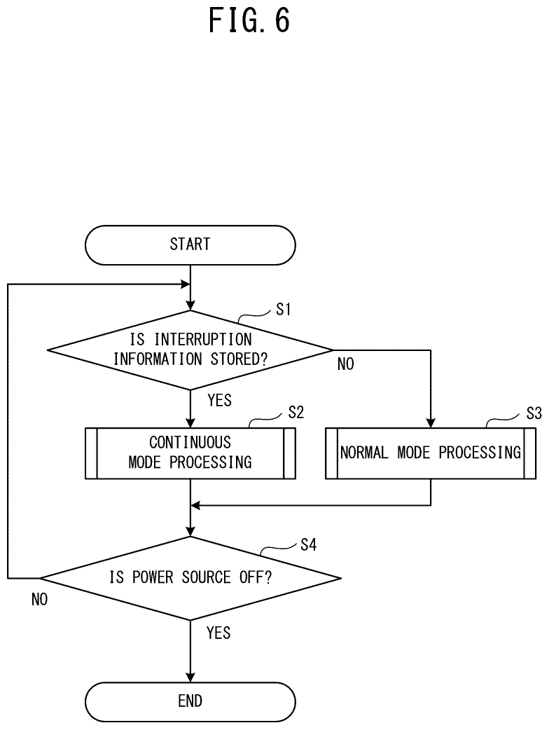

Main processing according to the present embodiment will be described with reference to FIG. 5 to FIG. 9. The main processing shown in FIG. 6 is started when the power source in the label printer 1 is turned on, and is performed by the CPU 91 in accordance with the programs stored in the ROM 92. The computer-readable instructions of the programs instruct the CPU 91 to perform the main processing. Data obtained by the steps of the processing are stored as appropriate in the RAM 94. As first and second specific examples, a case will be described in which a print object T is a six-letter alphabet string in which a character on the downstream side in the conveyance direction is updated per print object in order of the alphabet, such as when the first print object Tis “ABCDEF”, and the second print object Tis “ABCDEG”. The print object T is the same in each of the first and second specific examples, but a command input via the input portion 22 after the continuous printing processing is interrupted is different in each of the first and second specific examples. The main processing is performed at different timings in each of the first and second specific examples, but in order to simplify the description, the main processing of the first and second examples is explained in parallel below.

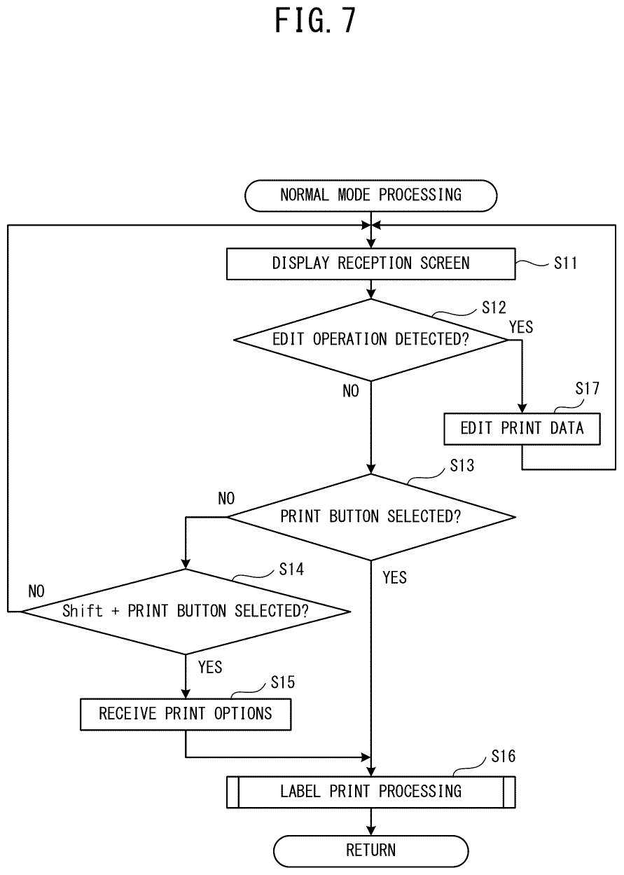

As shown in FIG. 6, the CPU 91 refers to the interruption information storage area 81 of the non-volatile memory 99, and determines whether the interruption information is stored (S1). When the interruption information is not stored (no at S1), the CPU 91 performs normal mode processing (S3). As shown in FIG. 7, in the normal mode processing, the CPU 91 displays, on the display 21, a reception screen G1 shown in FIG. 5 (S11). The reception screen G1 includes fields 51 and 52. The field 51 displays the print object specified by the user. The field 52 displays a remaining charge of the battery 31. The user operates the input portion 22 and inputs the print object to the field 51. Based on a detection result of the input portion 22, the CPU 91 determines whether an editing operation of the print object has been detected (S12). In the first and second specific examples, when the editing operation to continuously print the six character alphabet string has been detected (yes at S12), the CPU 91 edits the print data in accordance with the editing operation, and updates the field 51, as shown in a reception screen G2 (S17). In the field 51 of the reception screen G2, the print object T, and a size Q of the print object T are displayed. The size Q of the print object T is displayed as “(width of tape M) mm×(length of tape M in conveyance direction) mm”. In the reception screen G2, a length in the up-down direction corresponds to the width of the tape M, and a length in the left-right direction corresponds to the length of the tape M in the conveyance direction. The width of the tape M is defined based on the detection signal output from the cassette sensor 32. The length of the tape M in the conveyance direction is calculated in accordance with the print object T and a margin. The margin may be set in advance, or may be set by the user. The CPU 91 returns the processing to S11.

When the editing operation is not detected (no at S12), based on a detection result of the input portion 22, the CPU 91 determines whether a signal indicating that the print button has been individually selected has been detected (S13). When the selection of the print button is not detected (no at S13), based on a detection result of the input portion 22, the CPU 91 determines whether a signal indicating that the Shift key and the print button have been simultaneously selected has been detected (S14). When the signal indicating that the Shift key and the print button have been simultaneously selected is not detected (no at S14), the CPU 91 returns the processing to S11.

In the first and second specific examples, when the signal indicating that the Shift key and the print button have been simultaneously selected has been detected (yes at S14), the CPU 91 displays, on the display 21, a print option reception screen G3, and receives the setting of print options (S15). The print options received by the processing at S15 may be set as appropriate. As the print options, the printer 1 according to the present embodiment receives settings for five types of print option, namely, Copies, Page, Order, Invert, and Mirror. Copies sets a number of the print objects to be printed. Page sets whether to print specific pages or to print all the pages, when printing the print object that has a plurality of pages. Order sets a print order when printing a plurality of the print objects. Invert sets whether to invert black and white. Mirror sets whether to invert the print object in the left-right direction or the up-down direction. On the print option reception screen G3, Copies is set to 99, Page is set to All, Order is set to Sort, Invert is set to OFF, and Mirror is set to OFF. In the first and second specific examples, the user selects the print button after changing Copies from 99 to 198 and setting the print options.

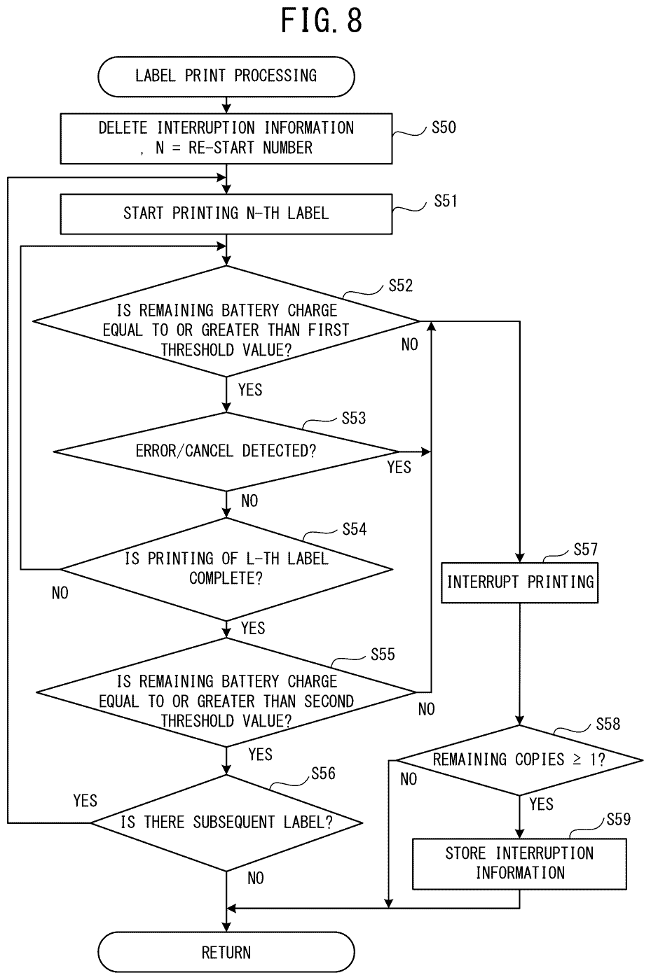

When the signal indicating that the print button has been individually selected has been detected (yes at S13), or subsequent to S15, the CPU 91 executes label print processing (S16). As shown in FIG. 8, the CPU 91 deletes the interruption information in the interruption information storage area 81 of the non-volatile memory 99, and sets a variable N to a start number (S50). In the first and second specific examples, since the interruption information is not stored in the interruption information storage area 81 of the non-volatile memory 99, at S50, the interruption information is not deleted. When the print options are not set, the start number is 1. When the print options are set, the start number is a number corresponding to the setting of the print options, and is 1 in the first and second specific examples.

The CPU 91 drives the drive circuits 96 and 97 in accordance with the print data to start printing of an N-th label (S51). When Nis 1, as shown by a screen G4, the CPU 91 displays, on the display 21, a progress status J of the continuous printing of the labels. The progress status J is displayed in a format of “Current number of copies/Total number of copies”. Based on the detection result of the sensor 33, the CPU 91 determines whether the remaining charge of the battery 31 is equal to or greater than a first threshold value (S52). The CPU 91 according to the present embodiment determines whether the remaining charge of the battery 31 is equal to or greater than the first threshold value, based on the voltage applied from the battery 31 and detected by the sensor 33. When the remaining charge of the battery 31 is equal to or greater than the first threshold value (yes at S52), the CPU 91 determines whether an error, or a command to cancel the printing has been detected (S53).

It is sufficient that a type of the error detected at S53, and an error detection method are established as appropriate. The CPU 91 according to the present embodiment detects the following four types of error. The CPU 91 detects the first error, as the error, when the operation of the cutting blade 43 has been detected based on the detection result of the sensor 34. The CPU 91 detects the second error, as the error, when the cassette sensor 32 no longer detects the cassette 17 during the continuous printing. The cassette sensor 32 according to the present embodiment is disposed, by the roller holder 27, to be in the vicinity of the cassette 17 and to detect the cassette 17 when the cassette 17 is installed in the cassette compartment 24 and the rear surface cover 5 is mounted to the main body portion 4. Both when the rear surface cover 5 has been removed from the main body portion 4, and when the cassette 17 is not installed in the cassette compartment 24, the cassette sensor 32 is separated from the cassette 17 by the roller holder 27 and does not detect the cassette 17. The CPU 91 detects the third error, as the error, when the temperature detected by the temperature sensor 35 during the continuous printing exceeds a threshold value, based on the temperature sensor 35. The threshold value may be set as appropriate taking into account the type of the tape M, a normal temperature when the print head 28 is heated, and the like, and in the present embodiment, is set to 80° C. The CPU 91 detects the fourth error, as the error, when a remaining amount of the tape M during the continuous printing processing becomes smaller than a threshold value. It is sufficient that the threshold value be set as appropriate, and the threshold value may be set in advance, may be automatically set in accordance with the length of the print object in the conveyance direction, or may be set by the user. The CPU 91 acquires an initial value of the length of the tape M, based on the detection result of the cassette sensor 32. The CPU 91 subtracts a used amount of the tape M from the initial value of the length of the tape M, and thus calculates the remaining amount of the tape M. The command to cancel the continuous printing is acquired via the input portion 22.

When the error is not detected, and the command to cancel the printing is not detected (no at S53), the CPU 91 determines whether the printing of the N-th label is complete (S54). When the printing of the N-th label is not complete (no at S54), the CPU 91 returns the processing to S52. When the printing of the N-th label is complete (yes at S54), based on the detection result of the sensor 33, the CPU 91 determines whether the remaining charge of the battery 31 is equal to or greater than a second threshold value (S52). The CPU 91 according to the present embodiment determines whether the remaining charge of the battery 31 is equal to or greater than the second threshold value based on the voltage applied from the battery 31 and detected by the sensor 33. The second threshold value is larger than the first threshold value. In other words, at S55, detection is made of a greater remaining charge of the battery 31 than at S52. When the remaining charge of the battery 31 is equal to or greater than the second threshold value (yes at S55), the CPU 91 determines whether there is the subsequent label to be printed (S56). When there is the subsequent label to be printed (yes at S56), the CPU 91 increments N by 1, and returns the processing to S51. When there is not the subsequent label to be printed (no at S56), the CPU 91 sets the label print processing as above, and returns the processing to the normal mode processing, or the continuous mode processing, as read from the label print processing.

In the first and second specific examples, when N is 50, when it is detected that the remaining charge of the battery 31 is less than the first threshold value (no at S52), or the error or the command to cancel the printing has been detected (yes at S53), the CPU 91 controls the drive circuits 96 and 97 to interrupt the continuous printing during execution (S57). In this case, the continuous printing is interrupted during the printing of the 50-th label. The CPU 91 displays, on the display 21, a screen G5 including a message prompting the user to replace the battery 31. After displaying the screen G5 on the display 21 for a predetermined period of time, the CPU 91 displays, on the display 21, a reception screen G6 that is the same as the reception screen G2.

The CPU 91 determines whether a remaining number of copies is equal to or greater than one (S58). When the continuous printing is interrupted during the printing of the N-th label, it may be set as appropriate whether to treat the N-th label as the printed label or as the label that has not yet been printed. When the continuous printing is interrupted during the printing of the N-th label, the CPU 91 according to the present embodiment treats the N-th label as the label that has not yet been printed, and thus, the remaining amount of the continuous printing is always equal to or greater than one (yes at S58). In this case, as the interruption information, the CPU 91 stores at least one selected from the group of the number of printed copies and an initial value of a re-start number, together with the print data, in the interruption information storage area 81 of the non-volatile memory 99 (S59). When the print options are set, the CPU 91 according to the present embodiment also includes the print options in the interruption information. The initial value of the re-start number is a value displayed on the display 21 as the re-start number indicating where to re-start the printing when restarting the continuous printing. A value corresponding to the number of printed copies already printed at the time of the interruption of the continuous printing at S57 is set as the initial value of the re-start number. The value corresponding to the number of printed copies may be the number itself of the number printed copies, or may be a value calculated by adding, subtracting, or the like a predetermined number to or from the number of printed copies. The CPU 91 sets the label printing processing as above, and returns the processing to the normal mode processing or the continuous mode processing.

When the remaining charge of the battery 31 is less than the second threshold value (no at S55), the CPU 91 interrupts the continuous printing during execution (S57). In this case, after printing the N-th label, the continuous printing is interrupted before starting to print an (N+1)-th label. When the remaining number of copies in the continuous printing is equal to or greater than one (yes at S58), the CPU 91 performs the processing at S59. When the remaining number of copies in the continuous printing is zero (no at S58), or after the processing at S59, the CPU 91 sets the label print processing as above, and returns the processing to the normal mode processing, or to the continuous mode processing.

In the first and second specific examples, after S16 shown in FIG. 7, the CPU 91 ends the normal mode processing and returns the processing to the main processing. In the main processing shown in FIG. 6, after S3, the CPU 91 determines whether to turn the power source OFF (S4). When the power source is not to be turned OFF (no at S4), the CPU 91 returns the processing to S1. When, based on the detection result of the input portion 22, a command to turn the power source OFF has been detected, or when, in the label print processing, the continuous printing is interrupted due to the remaining charge of the battery 31 being less than the first threshold value or the second threshold value, the CPU 91 determines that the power source is to be turned OFF. When the power source is to be turned OFF (yes at S4), the CPU 91 ends the main processing after performing processing to end the processing.

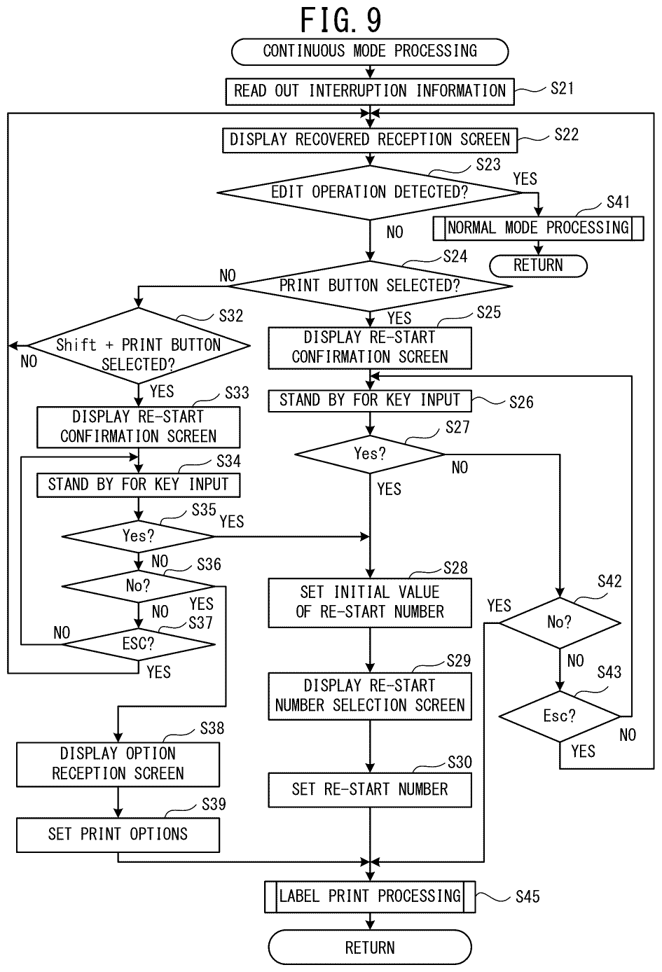

In the label print processing of the first and second specific examples, after the continuous printing is interrupted due to the remaining charge of the battery 31 being less than the second threshold value, when the user replaces the battery 31, and turns the power source of the printer 1 ON, the CPU 91 determines at S1 that the interruption information is stored (yes at S1), and executes the continuous mode processing (S2). As shown in FIG. 9, in the continuous mode processing, the CPU 91 reads out the interruption information stored in the interruption information storage area 81 of the non-volatile memory 99 to the RAM 94 (S21). Based on the interruption information read out by the processing at S21, the CPU 91 displays, on the display 21, a recovery screen G7, which is the recovered reception screen G6 displayed before the interruption of the continuous printing (S22). Based on the detection result of the input portion 22, the CPU 91 determines whether an operation to edit the print object T displayed on the recovery screen G7 has been detected (S23). When the operation to edit the print object T has been detected (yes at S23), the CPU 91 does not perform the processing to re-start the interrupted continuous printing, performs the normal mode processing in the same manner as at S3 shown in FIG. 6 (S41), and returns the processing to the main processing.

When the operation to edit the print object T has not been detected (no at S23), based on the detection result of the input portion 22, the CPU 91 determines whether the signal indicating that the print button has been individually selected has been detected (S24). In the first specific example, when the selection of the print button has been detected (yes at S24), the CPU 91 displays a re-start confirmation reception screen G8 on the display 21, and receives a command as to whether to re-start the continuous printing (S25). The re-start confirmation reception screen G8 includes “Yes” and “No” as options P of a response as to whether to re-start the continuous printing, and a cursor K that causes the selected option P to be displayed in a black and white inverted manner. The re-start confirmation reception screen G8 indicates a state in which “Yes” is selected. The user moves the cursor K in the up-down direction and selects an OK button to input “Yes” or “No”.

Based on the detection result of the input portion 22, the CPU 91 stands by until one of the keys is selected (S26), and when one of the keys has been selected, determines whether the selection of “Yes” has been detected (S27). In the first specific example, when the selection of “Yes” has been detected (yes at S27), based on the interruption information read out at S21, the CPU 91 sets the initial value of the re-start number (S28). The CPU 91 displays, on the display 21, a re-start number selection screen G9 that includes the initial value of the re-start number set at S28 (S29). The user confirms the initial value of the re-start number displayed on the re-start number selection screen G9, updates the re-start number if necessary, and sets the re-start number (S30). Based on the print data included in the interruption information, the CPU 91 re-starts the continuous printing from the re-start number set at S30, and executes the label print processing (S45). In the label print processing performed at S45, the re-start number set at S30 is set as the variable N at S50. When N is 51, as shown by a screen G10, the CPU 91 displays the progress status J of the continuous printing of the labels on the display 21, and updates the progress status J in accordance with the number of printed copies.

When the selection of “Yes” is not detected (no at S27), the CPU 91 determines whether a selection of “No” has been detected (S42). When the selection of “No” has been detected (yes at S42), the CPU 91 executes the label print processing based on the print data included in the interruption information read out at S21 (S45). In the label print processing in this case, a value according to the print options included in the interruption information is set as the variable N. When the selection of “No” is not detected (no at S42), the CPU 91 determines whether a selection of “Esc” has been detected (S43). When the selection of “Esc” has been detected (yes at S43), the CPU 91 returns the processing to S22. When the selection of “Esc” is not detected (no at S43), the CPU 91 returns the processing to S26.

When the selection of the print button is not detected (no at S24), based on the detection result of the input portion 22, the CPU 91 determines whether the signal indicating that the Shift key and the print button have been simultaneously selected has been detected (S32). When the signal indicating that the Shift key and the print button have been simultaneously selected is not detected (no at S32), the CPU 91 returns the processing to S22. In the second specific example, when the signal indicating that the Shift key and the print button have been simultaneously selected has been detected (yes at S32), the CPU 91 displays the re-start confirmation reception screen G8 on the display 21 in a similar manner to S25, and receives the command as to whether to re-start the continuous printing (S33).

Based on the detection result of the input portion 22, the CPU 91 stands by until one of the keys is selected (S34), and when one of the keys is selected, determines whether the selection of “Yes” has been detected (S35). When the selection of “Yes” has been detected (yes at S35), based on the interruption information read out at S21, the CPU 91 sets the initial value of the re-start number (S28), and, in a similar manner to when the selection of the print button has been detected as described above, performs the processing at S29, S30, and S45.

When the selection “Yes” is not detected (no at S35), the CPU 91 determines whether the selection of “No” has been detected (S36). When the selection of “No” has been detected (yes at S36), the CPU 91 displays an option reception screen G11 on the display 21 (S38), and receives the setting of the print options in a similar manner to the processing at S15 (S39). The CPU 91 executes the label print processing (S45), which performs the printing in accordance with the print data included in the interruption information read out at S21, and in accordance with the print options set at S39. In the label print processing in this case, a value according to the print options set at S39 is set as the variable N. When Nis 1, as shown by a screen G12, the CPU 91 displays the progress status J of the continuous printing of the labels on the display 21.

When the selection of “No” is not detected (no at S36), the CPU 91 determines whether the selection of “Esc” has been detected (S37). When the selection of “Esc” has been detected (yes at S37), the CPU 91 returns the processing to S22. When the selection of “Esc” is not detected (no at S37), the CPU 91 returns the processing to S34. Subsequent to S45, the CPU 91 ends the continuous mode processing, and returns the processing to the main processing shown in FIG. 6. Subsequent to S2, when the power source is not turned OFF (no at S4), the CPU 91 returns the processing to S1, and when the power source has been turned OFF (yes at S4), the CPU 91 ends the main processing.

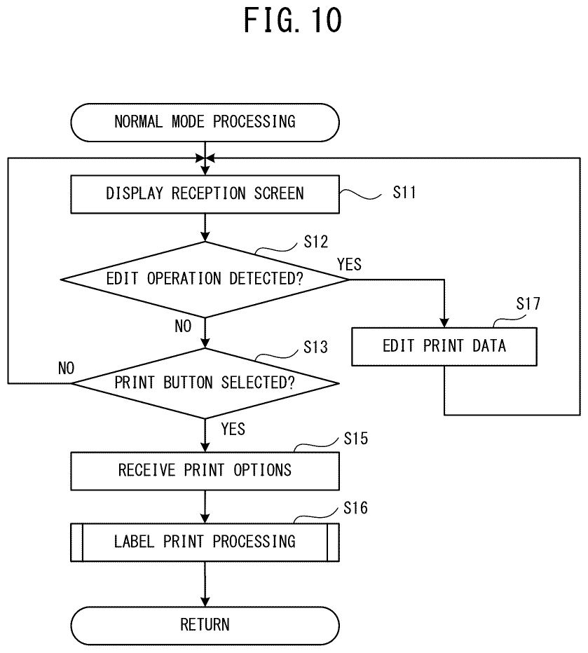

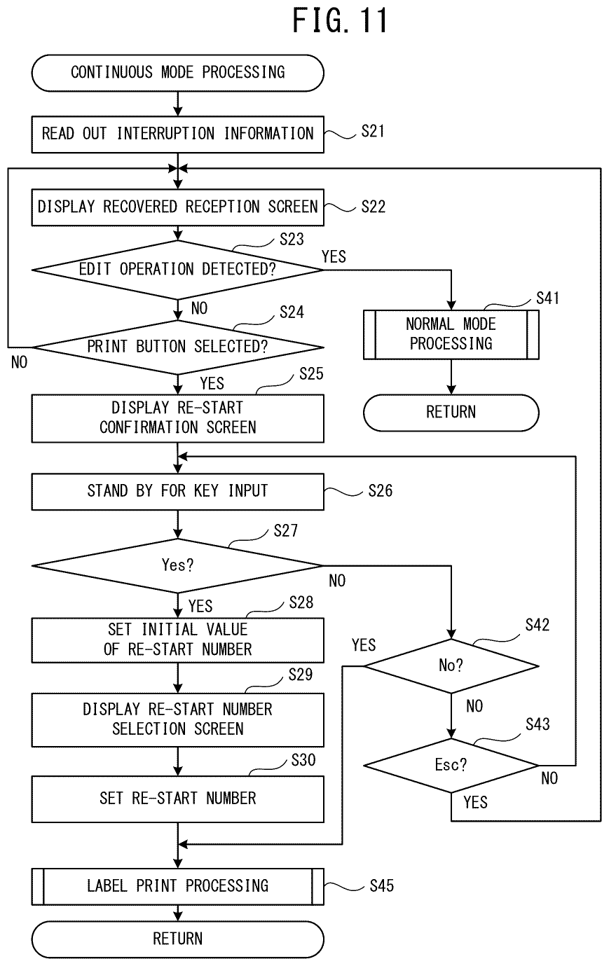

The main processing according to the above-described embodiment may be changed as appropriate. For example, the printer 1 may perform normal mode processing according to a modified example shown in FIG. 10, as the normal mode processing performed in the main processing, may perform continuous mode processing according to a modified example shown in FIG. 11, as the continuous mode processing performed in the main processing, and need not necessarily receive the setting of the print options. In FIG. 10 and FIG. 11, the same reference numeral is allocated to the processing that is the same as that of the above-described embodiment. As shown in FIG. 10, in the normal mode processing according to the modified example, the processing at S14 and S15 is omitted, and when the input of the print button is not detected (no at S13), the CPU 91 returns the processing to S11. As shown in FIG. 11, in the continuous mode processing according to the modified example, the processing from S32 to S39 is omitted, and when the input of the print button is not detected (no at S24), the CPU 91 returns the processing to S22.

The printer 1 according to the above-described embodiment includes the print head 28, the roller 26 that conveys the tape M, the display 21, and the CPU 91. Based on the print data, the CPU 91 drives the print head 28 and the roller 26 to perform the continuous printing on the tape M (S51 that is performed at S16). After the continuous printing has been interrupted, when re-starting the continuous printing, the CPU 91 displays, on the display 21, a value that accords with the number of printed copies already printed up to the time of the interruption, as the initial value of the re-start number (S29), and receives the input of the re-start number (S30). Based on the print data, the CPU 91 drives the print head 28 and the roller 26 to re-start the continuous printing from the re-start number (S51 performed at S45 subsequent to S30). Since the printer 1 displays, on the display 21, the value that accords with the number of printed copies as the initial value of the re-start number, the user can specify the re-start number while referring to the initial value. Thus, the printer 1 contributes to re-starting the continuous printing using a simpler operation than in the related art, even when the continuous printing has been interrupted.

When, during the continuous printing processing, the remaining charge of the battery 31 supplying the power to the printer 1 falls below the threshold value (no at S52, no at S55), the CPU 91 interrupts the continuous printing processing (S57). The printer 1 contributes to automatically interrupting the continuous printing processing when the remaining charge of the battery 31 supplying the power to the printer 1 falls below the first threshold value or the second threshold value. By detecting the remaining charge of the battery 31 at two stages, using the first threshold value and the second threshold value, the printer 1 according to the present embodiment contributes to continuing the printing using the power of the battery 31 to the utmost possible extent, while reducing a possibility that the continuous printing may be interrupted during the printing of the N-th print object T.

The printer 1 is provided with the cutting blade 43 that cuts the tape M. When the operation of the cutting blade 43 has been detected (yes at S53), the CPU 91 interrupts the continuous printing processing (S57). The printer 1 contributes to automatically interrupting the continuous printing processing when the operation of the cutting blade 43 has been detected.

The printer 1 is provided with the cassette compartment 24 that detachably supports the cassette 17, and the cassette sensor 32 that detects the cassette 17 installed in the cassette compartment 24. The tape M is housed in the cassette 17 that is detachably installed in the cassette compartment 24. When the cassette 17 is no longer detected by the cassette sensor 32 during the continuous printing (yes at S53), the CPU 91 interrupts the continuous printing processing (S57). The printer 1 contributes to automatically interrupting the continuous printing processing when the cassette sensor 32 no longer detects the cassette 17.

The printer 1 is provided with the temperature sensor 35 that detects the temperature of the print head 28. When, during the continuous printing, the temperature detected by the temperature sensor 35 exceeds the threshold value (yes at S53), the CPU 91 interrupts the continuous printing processing (S57). The printer 1 contributes to automatically interrupting the continuous printing processing when overheating of the print head 28 has been detected.

When, during the continuous printing processing, the remaining amount of the tape M becomes smaller than the threshold value, the CPU 91 interrupts the continuous printing processing (S57). The printer 1 contributes to automatically interrupting the continuous printing processing when a state has been detected in which the continuous printing on the tape M cannot be continued.

The printer 1 is provided with the non-volatile memory 99. When the continuous printing processing is interrupted, the CPU 91 stores, in the non-volatile memory 99, at least one selected from the group of the number of printed copies and the initial value, together with the print data, as the interruption information (S59). The CPU 91 executes the processing at S29 and at S30 based on the interruption information stored in the non-volatile memory 99. The printer 1 contributes to performing the processing to receive the re-start number using comparatively simple processing, based on the interruption information stored in the non-volatile memory 99.

The printer 1 is provided with the non-volatile memory 99. When the continuous printing processing is interrupted, the CPU 91 stores, in the non-volatile memory 99, at least one selected from the group of the number of printed copies and the initial value, together with the print data, as the interruption information (S59). The CPU 91 executes the processing at S29 and at S30 based on the interruption information stored in the non-volatile memory 99. At S51 performed at S45 subsequent to S30, the CPU 91 drives the print head 28 and the roller 26 based on the print data to re-starts the continuous printing from the re-start number using the print settings stored in the non-volatile memory 99 as the interruption information. The printer 1 contributes to performing the processing to receive the re-start number using the comparatively simple processing, based on the interruption information stored in the non-volatile memory 99, and contributes to re-starting the continuous printing using the print settings before the interruption.

After interrupting the continuous printing processing, the CPU 91 displays the print settings at the time of the interruption on the display 21, and receives the input to re-set the print settings (S38, S39). The CPU 91 drives the print head 28 and the roller 26 based on the print data to perform the printing using the print settings that have been re-set (S51 performed at S45 subsequent to S39). The printer 1 contributes to re-starting the continuous printing using the print settings that have been re-set.

When the input to re-set the print settings has been received, the CPU 91 drives the print head 28 and the roller 26 based on the print data to perform the printing using the print settings that have been re-set (S51 performed at S45 subsequent to S39). When the input to re-set the print settings is not received, in print re-start processing, the CPU 91 drives the print head 28 and the roller 26 based on the print data to re-start the continuous printing from the re-start number, using the print settings stored in the non-volatile memory 99 as the interruption information (S51 performed at S45 subsequent to S30). Depending on whether the input to re-set the print settings has been received, the printer 1 contributes to switching between whether to re-start the continuous printing based on the print data, or to perform the printing based on the print data.

When the power source of the printer 1 is turned ON, when the interruption information is not stored in the non-volatile memory 99, the CPU 91 displays the reception screen G1 on the display 21 to receive specification of the print data (S11). When the power source of the printer 1 is turned ON, when the interruption information is stored in the non-volatile memory 99, the CPU 91 displays, on the display 21, the recovery screen G7, in which an image representing the print data stored in the non-volatile memory 99 as the interruption information is added to the reception screen (S22). Depending on whether the interruption information is stored in the non-volatile memory 99, the printer 1 contributes to switching between whether to execute the processing to display the reception screen G1, or execute the processing to display the recovery screen G7.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The label printer according to the present disclosure is not limited to the above-described embodiment and various modifications may be added insofar as they do not depart from the scope and gist of the present disclosure. For example, the following modifications may be added as appropriate. The present disclosure can be implemented in various modes, and, for example, the present disclosure may be realized by a print program controlled by the label printer, a non-transitory computer-readable medium storing the print program, a print method executed by the control of the label printer, and the like.

(A) The configuration of the printer 1 may be changed as appropriate. The printer 1 may omit at least one selected from the group of the cassette sensor 32, the temperature sensor 35, and the cutting blade 43, or the arrangement and configuration thereof may be changed as appropriate. For example, the cassette sensor 32 may be configured to be able to detect the cassette 17 when the rear surface cover 5 is removed from the main body portion 4. The cutting blade 43 need not necessarily be provided with the fixed blade 48, and a mode may be adopted in which the movable blade 49 is moved and the tape M is pressed and cut as a result of pressing the movable blade 49 together with the tape M against a receiving member. It is sufficient that the cutting blade 43 be able to perform the cutting operation by at least one selected from a group of a manual operation and an automatic operation. The configuration of the sensor 34 may be changed as appropriate in accordance with the configuration of the cutting blade 43. In addition to the switch and the keyboard, the input portion 22 may be a touch panel, a mouse, a joystick, or the like. The type of the cassette 17 that can be installed in the printer 1, and the type and configuration of the tape M that can be housed may be changed as appropriate. The printer 1 may be a device capable of performing the printing on the tape M that is not housed in the cassette 17. The printer 1 may be a type of label printer that is placed on a table and used.

(B) The program including the commands for executing the main processing may be stored in a storage device until the CPU 91 of the printer 1 executes the corresponding program. Thus, an acquisition method of the program, an acquisition path, and a device on which the program is stored may each be changed as appropriate. The program that is executed by the CPU 91 may be received via a cable or via wireless communication from another device, and may be stored in a storage device, such as a storage portion or the like. Examples of the other device include a PC, and a server that is connected via a network.

(C) In the continuous mode processing, the CPU 91 may omit the processing from S33 to S37, and, when the signal indicating that the Shift key and the print button have been simultaneously selected has been detected (yes at S32), may perform the processing at S38. In a similar manner, in the continuous mode processing, the CPU 91 may omit the processing at S25 to S27, at S42, and at S43, and when the signal indicating that the print button has been selected has been detected (yes at S24), may perform the processing at S28. At S33, the CPU 91 may display a different screen from that of the processing at S25, and may receive a command as to whether to set the print options. In the continuous mode processing, after setting the print options (S39), the CPU 91 may perform the processing from S28 to S30 in accordance with a command from the user, or automatically, and may re-start the continuous printing using the print options set at S39. The type and number of print options that can be set on the printer 1 as the print settings may be changed as appropriate. The type of the keys of the input portion 22, and a relationship of the type of command according to the keys may be changed as appropriate.

Conditions for automatically interrupting the continuous printing processing may be changed as appropriate. For example, during the continuous printing processing, the CPU 91 may omit at least one selected from the group of S52 and S55, and, when the remaining charge of the battery 31 supplying the power to the printer 1 falls below the threshold value, the CPU 91 may continue to perform the continuous printing without interrupting the continuous printing processing. When the operation of the cutting blade 43 has been detected, the CPU 91 may continue the continuous printing without interrupting the continuous printing processing. When the cassette sensor 32 no longer detects the cassette 17, the CPU 91 may continue the continuous printing without interrupting the continuous printing processing. When the temperature detected by the temperature sensor 35 exceeds the threshold value during the continuous printing, the CPU 91 may continue the continuous printing without interrupting the continuous printing processing. In this case, the CPU 91 may omit the temperature sensor 35. When the remaining amount of the tape M has become less than the threshold value during the continuous printing processing, the CPU 91 may continue the continuous printing without interrupting the continuous printing processing. In this case, the CPU 91 need not necessarily acquire the remaining amount of the tape M. Each of the type and number of errors detected at S53, the method of detecting the errors, and the threshold values used in the detection of the errors may be changed as appropriate.

During the replacement of the battery 31, when a volatile memory capable of electric conduction is provided, the CPU 91 may store the interruption information in the volatile memory instead of the non-volatile memory 99. The interruption information may be changed as appropriate, as long as the interruption information includes at least one selected from the group of the number of printed copies and the initial value, together with the print data. Specifically, the interruption information may include the number of printed copies and need not necessarily include the initial value of the re-start number. The interruption information may include the initial value of the re-start number and need not necessarily include the number of printed copies. The interruption information may include both the number of printed copies and the initial value of the re-start number. The interruption information need not necessarily include the print settings. In this case, when re-starting the printing, the CPU 91 may receive the new print settings and re-start the continuous printing based on the set print settings, or may re-start the continuous printing using default print settings. The CPU 91 need not necessarily switch whether to re-start the continuous printing or to start the new continuous printing without re-starting the continuous printing, depending on whether the input to re-set the print settings has been received. When the power source of the printer 1 is turned ON, the printer 1 need not necessarily switch the reception screen depending on whether the interruption information is stored in the non-volatile memory 99.

The above-described modified examples may be combined insofar as no contradictions arise. In addition to combinations exemplified in the scope of the claims, an applicant of the present application has the intention of acquiring patent rights for combined aspects obtained by combinations of the above-described embodiment and modified examples, insofar as they do not depart from the scope and gist of the present disclosure, and insofar as no contradictions arise.

What is claimed is:

1. A label printer comprising:
a print head;
a roller configured to convey a tape;
a display;
a processor configured to execute:
continuous printing processing of driving the print head and the roller based on print data to perform continuous printing on the tape;
re-start number reception processing of, when re-starting the continuous printing subsequent to interruption of the continuous printing processing, displaying, on the display, a value corresponding to a number of printed copies already printed at the time of interruption, as an initial value of a re-start number, and receiving input of the re-start number; and
print re-start processing of driving the print head and the roller based on the print data to re-start the continuous printing from the re-start number.

2. The label printer according to claim 1, wherein
the processor is further configured to execute:
interruption processing of interrupting the continuous printing processing when a remaining charge of a battery supplying power to the label printer falls below a threshold value during the continuous printing processing.

3. The label printer according to claim 1, further comprising:
a cutting blade configured to cut the tape, wherein
the processor is further configured to execute:
interruption processing of interrupting the continuous printing processing when operation of the cutting blade is detected.

4. The label printer according to claim 1, further comprising:
a cassette compartment configured to support a cassette in an attachable and detachable manner; and
a cassette sensor configured to detect the cassette installed in the cassette compartment, wherein
the tape is housed in the cassette attachable to and detachable from the cassette compartment, and
the processor is further configured to execute:
interruption processing of interrupting the continuous printing processing when the cassette sensor no longer detects the cassette during the continuous printing.

5. The label printer according to claim 1, further comprising:
a temperature sensor configured to detect a temperature of the print head, wherein
the processor is further configured to execute:
interruption processing of interrupting the continuous printing processing when the temperature detected by the temperature sensor during the continuous printing exceeds a threshold value.

6. The label printer according to claim 1, wherein
the processor is further configured to execute:
interruption processing of interrupting the continuous printing processing when a remaining amount of the tape falls below a threshold value during the continuous printing processing.

7. The label printer according to claim 1, further comprising:
a non-volatile memory, wherein
the processor is further configured to execute:
storage control processing of, when the continuous printing processing is interrupted, storing at least one selected from a group of the number of printed copies and the initial value, together with the print data, as interruption information, in the non-volatile memory; and
the re-start number reception processing based on the interruption information stored in the non-volatile memory.

8. The label printer according to claim 1, further comprising:
a non-volatile memory, wherein
the processor is further configured to execute:
storage control processing of, when the continuous printing processing is interrupted, storing at least one selected from a group of the number of printed copies and the initial value, together with the print data, and with print settings, as interruption information, in the non-volatile memory; and
the re-start number reception processing based on the interruption information stored in the non-volatile memory, and
the print re-start processing includes driving the print head and the roller based on the print data, and re-starting the continuous printing from the re-start number using the print settings stored in the non-volatile memory as the interruption information.

9. The label printer according to claim 8, wherein
the processor is further configured to execute:
print re-setting reception processing of displaying the print settings at the time of interruption, on the display, and receiving an input to re-set the print settings, when re-starting the continuous printing subsequent to interruption of the continuous printing processing; and
print control processing of driving the print head and the roller based on the print data to perform printing using the print settings re-set in the print re-setting reception processing.

10. The label printer according to claim 9, wherein
when the input to re-set the print settings is received, the print control processing includes driving the print head and the roller based on the print data to perform the printing using the print settings re-set in the print re-setting reception processing, and
when the input to re-set the print settings is not received, the print re-start processing includes driving the print head and the roller based on the print data to re-start the continuous printing from the re-start number, using the print settings stored in the non-volatile memory as the interruption information.

11. The label printer according to claim 7, wherein
the processor is further configured to execute:
first display processing of displaying, on the display, a reception screen to receive specification of print data, when a power source of the label printer is turned ON and the interruption information is not stored in the non-volatile memory; and
second display processing of displaying, on the display, a recovery screen obtained by adding, to the reception screen, an image representing the print data stored in the non-volatile memory as the interruption information, when the power source of the label printer is turned ON and the interruption information is stored in the non-volatile memory.
